(19) United States
(12) Patent Application Publication
(10) Pub. No.: US 2020/0200668 A1
(43) Pub. Date: Jun. 25, 2020

(54) PARTICLE DETECTION ELEMENT AND PARTICLE DETECTOR

(71) Applicant: NGK INSULATORS, LTD., Nagoya-City (JP)

(72) Inventors: Keiichi KANNO, Nagoya-City (JP); Hidemasa OKUMURA, Nagoya-City (JP); Kazuyuki MIZUNO, Nagoya-City (JP)

(73) Assignee: NGK INSULATORS, LTD., Nagoya-City (JP)

(21) Appl. No.: 16/807,309

(22) Filed: Mar. 3, 2020

Related U.S. Application Data
(63) Continuation of application No. PCT/JP2018/029055, filed on Aug. 2, 2018.

(30) Foreign Application Priority Data
Sep. 6, 2017 (JP) 2017-171120

(51) Int. Cl. G01N 15/06

(52) U.S. Cl. CPC G01N 15/0656

(57) ABSTRACT

A particle detection element includes: a casing having a gas flow passage; an electric charge generating unit that imparts charges to particles in a gas introduced into the casing to thereby form charged particles; a collecting unit including at least one collecting electrode that is disposed so as to be exposed to the gas flow passage and collects a collection target that is the charged particles or the charges not imparted to the particles; and a heating unit that heats the collecting electrode. The casing includes at least one collecting electrode-disposed wall on which at least one of the at least one collecting electrode is disposed. At least one of the at least one collecting electrode-disposed wall has a thin-central wall shape whose thickness in a cross section perpendicular to a center axis of the gas flow passage is smaller in a central portion than in other portions.

### BACKGROUND OF THE INVENTION

### 1. Field of the Invention

The present invention relates to a particle detection element and to a particle detector.

### 2. Description of the Related Art

In one known conventional particle detector, electric charges are imparted to particles in a measurement gas introduced into a casing to collect the charged particles by a measurement electrode, and the number of particles is measured based on the amount of charges on the collected particles (e.g., PTL 1). The particle detector in PTL 1 includes a heater for heating the measurement electrode. By heating the measurement electrode using the heater, the particles adhering to the measurement electrode are removed, and the measurement electrode is refreshed.

### CITATION LIST

### Patent Literature

PTL 1: International Publication No. WO2015/146456

### SUMMARY OF THE INVENTION

There has been a desire to rapidly remove the particles adhering to the electrode of such a particle detector.

The present invention has been made to solve the foregoing problem, and a principal object of the invention is to remove particles adhering to a collecting electrode in a shorter time.

To achieve the above principal object, the present invention adopts the following measures.

A particle detection element of the present invention is used to detect particles in a gas, the particle detection element includes:

a casing having a gas flow passage through which the gas passes;

an electric charge generating unit that imparts charges generated by a discharge to the particles in the gas introduced into the casing to thereby form charged particles;

a collecting unit including at least one collecting electrode that is disposed inside the casing so as to be exposed to the gas flow passage and collects a collection target that is the charged particles or the charges not imparted to the particles; and

a heating unit that heats the collecting electrode,

wherein the casing includes at least one collecting electrode-disposed wall on which at least one of the at least one collecting electrode is disposed, and

wherein at least one of the at least one collecting electrode-disposed wall has a thin-central wall shape whose thickness in a cross section perpendicular to a center axis of the gas flow passage is smaller in a central portion than in other portions.

In this particle detection element, the electric charge generating unit generates electric charges to thereby convert particles in the gas into charged particles, and the collecting electrode collects the collection target (the charged particles or the charges not imparted to the particles). Since a physical quantity varies according to the collection target collected by the collecting electrode, the use of the particle detection element allows the particles in the gas to be detected. In this case, during the use of the particle detection element, particles gradually adhere to the collecting electrode. The concentration of the particles in the gas tends to be higher in a region close to the center axis of the gas flow passage in the casing. Therefore, the particles are more likely to adhere to a portion of the collecting electrode that is close to the center axis of the gas flow passage. In the particle detection element of the present invention, at least one of the at least one collecting electrode-disposed wall of the casing on which the collecting electrode is disposed has the thin-central wall shape whose thickness in a cross section perpendicular to the center axis of the gas flow passage is smaller in a central portion than in other portions. Therefore, in the collecting electrode-disposed wall having the thin-central wall shape, the central portion has a smaller heat capacity than the other portions, and the temperature of this portion is more likely to increase. In this case, when the heater unit heats the particles adhering to the collecting electrode disposed on the collecting electrode-disposed wall having the thin-central wall shape, the temperature of a portion of the collecting electrode to which the particles are more likely to adhere (the above-described portion close to the center axis of the gas flow passage) is more likely to increase. Therefore, in the collecting electrode disposed on the collecting electrode-disposed wall having the thin-central wall shape, the temperature of the portion of the collecting electrode to which a large number of particles adhere can be rapidly increased to burn the particles, and the particles adhering to the collecting electrode can be removed in a shorter time. In this case, the particle detection element of the present invention may be used to detect the amount of the particles in the gas. The “amount of the particles” may be, for example, at least one of the number, mass, and surface area of the particles.

In the particle detection element of the present invention, a cross section of the gas flow passage that is perpendicular to the center axis of the gas flow passage may not be circular (perfect circular) at least in a portion in which the collecting electrode-disposed wall having the thin-central wall shape is present. For example, the cross section of the gas flow passage may be elliptical or polygonal.

In the particle detection element of the present invention, the casing may include a partition that partitions the gas flow passage, and at least one of the at least one collecting electrode-disposed wall having the thin-central wall shape may serve as the partition. In this case, the casing may include a plurality of the collecting electrode-disposed walls having the thin-central wall shape, and at least one of the collecting electrode-disposed walls having the thin-central wall shape may serve as an outer wall of the casing. Specifically, at least one of the collecting electrode-disposed walls having the thin-central wall shape serves as the outer wall of the casing, and at least one of the collecting electrode-disposed walls serves as the partition.

In the particle detection element of the present invention, at least one of the at least one collecting electrode-disposed wall having the thin-central wall shape may have a shape whose thickness in the cross section gradually decreases toward the central portion. In this case, the strength of the collecting electrode-disposed wall tends to be higher than, for example, a collecting electrode-disposed wall having the thin-central wall shape with a step portion at which the thickness changes abruptly.

In the particle detection element of the present invention, at least one of the at least one collecting electrode may have the thin-central wall shape. In this case, the heat capacity of the collecting electrode having the thin-central wall shape is small in a portion located at the center of the gas flow passage, and the temperature of the portion of the collecting electrode to which particles are more likely to adhere is more likely to increase. Therefore, the particles adhering to the collecting electrode can be removed in a shorter time. In this case, at least one of the at least one collecting electrode having the thin-central wall shape may have a shape whose thickness in the cross section gradually decreases toward the central portion.

In the particle detection element of the present invention, the collecting unit may include at least one electric field generating electrode that is exposed to the gas flow passage and generates an electric field that causes the collection target to move toward at least one of the at least one collecting electrode, and the casing may include at least one electric field generating electrode-disposed wall on which at least one of the at least one electric field generating electrode is disposed. Moreover, at least one of the at least one electric field generating electrode-disposed wall may have the thin-central wall shape. In this case, in the electric field generating electrode disposed on the electric field generating electrode-disposed wall having the thin-central wall shape, as in the collecting electrode disposed on the collecting electrode-disposed wall having the thin-central wall shape, the temperature of the portion to which a large number of particles adhere can be rapidly increased to burn the particles.

In this case, each of the at least one electric field generating electrode may be disposed so as to face at least one of the at least one collecting electrode or may be disposed so as to face a corresponding one of the at least one collecting electrode. At least one of the at least one electric field generating electrode-disposed wall having the thin-central wall shape may serve as the partition or may serve as the outer wall of the casing. At least one of the at least one electric field generating electrode-disposed wall having the thin-central wall shape may have a shape whose thickness in the cross section gradually decreases toward the central portion.

In the particle detection element of the present invention, a cross section of the gas flow passage that is perpendicular to the center axis of the gas flow passage may have a rectangular shape. The “rectangular shape” is meant to include a substantially rectangular shape, and the gas flow passage may have a shape that is not strictly rectangular because the collecting electrode-disposed wall has the thin-central wall shape.

The particle detection element of the present invention may include a plurality of exposed electrodes that include the at least one collecting electrode and are exposed to the gas flow passage. The casing may have a connection wall portion having the thin-central wall shape and having a connection surface that is part of an inner circumferential surface exposed to the gas flow passage and connects at least two of the plurality of exposed electrodes to each other. The heating unit may heat the connection wall portion. During the use of the particle detection element, part of the particles gradually adhere to the inner circumferential surface of the casing, and the adhered particles may form a short circuit path between the exposed electrodes. However, when the heating unit heats the connection wall portion, the particles adhering to the connection surface between the exposed electrodes can be removed. Moreover, in the connection wall portion having the thin-central wall shape, the heat capacity of a portion located at the center of the gas flow passage is small. Therefore, although the connection surface of the connection wall portion has a portion to which particles are more likely to adhere, the temperature of this portion can be easily increased. In this case, the heating unit can remove the particles adhering to the connection surface in a shorter time. Therefore, in this particle detection element, for example, the formation of a short circuit path can be prevented. Moreover, even when a short circuit path is formed, the particle detection element can rapidly recover from the short-circuited state. In this case, the exposed electrodes may be at least two of at least one of the at least one collecting electrode, at least one of the at least one electric field generating electrode, and a plurality of electrodes included in the electric charge generating unit.

The particle detector of the present invention includes: the particle detection element according to any one of the above modes; and a detection unit that detects the particles based on a physical quantity that varies according to the collection target collected by the collecting electrode. Therefore, this particle detector has the same effects as those of the particle detection element of the present invention described above. For example, one of the effects is that particles adhering to the collecting electrode can be removed in a shorter time. In this case, the detection unit may detect the amount of the particles based on the physical quantity. The “amount of the particles” may be, for example, at least one of the number, mass, and surface area of the particles. In this particle detector, when the collection target is charges not imparted to the particles, the detection unit may detect the particles based on the physical quantity and the charges (e.g., the number of charges or the amount of charges) generated by the electric charge generating unit.

In the present description, the “charges” are meant to include positive charges, negative charges, and ions. The phrase “to detect the amount of particles” is meant to include the case where the amount of particles is measured and the case where whether or not the amount of particles falls within a prescribed numerical range is judged (whether or not the amount of particles exceeds a prescribed threshold value is judged). The “physical quantity” may be any parameter that varies according to the number of collection target objects (the amount of charges) and is, for example, an electric current.

### BRIEF DESCRIPTION OF THE DRAWINGS

FIG. 1 is a perspective view showing a schematic structure of a particle detector 10.

FIG. 2 is an A-A cross-sectional view of FIG. 1.

FIG. 3 is a partial cross-sectional view of a B-B cross section of FIG. 1.

FIG. 4 is an exploded perspective view of a particle detection element 11.

FIG. 5 is a cross-sectional view of a second outer wall 115b in a modification.

FIG. 6 is a partial cross-sectional view of a casing 112 in a modification.

FIG. 7 is a cross-sectional view of a particle detector 710 in a modification.

### DETAILED DESCRIPTION OF THE INVENTION

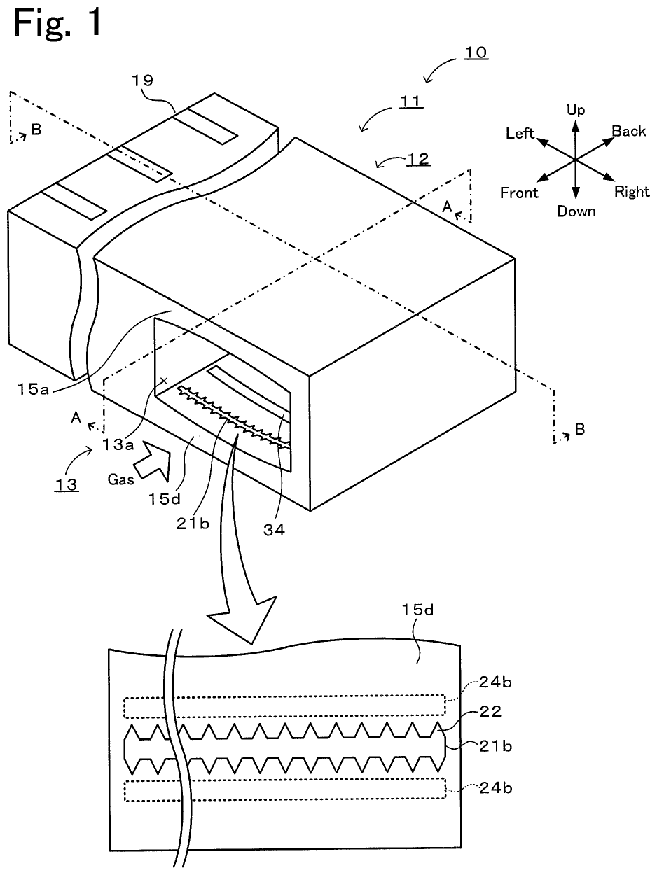

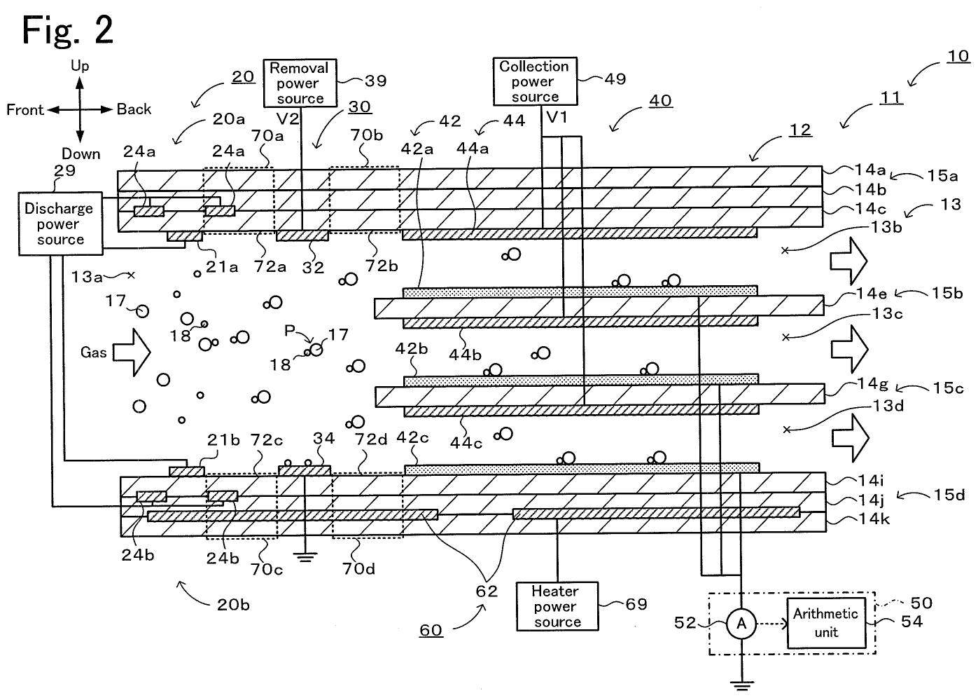

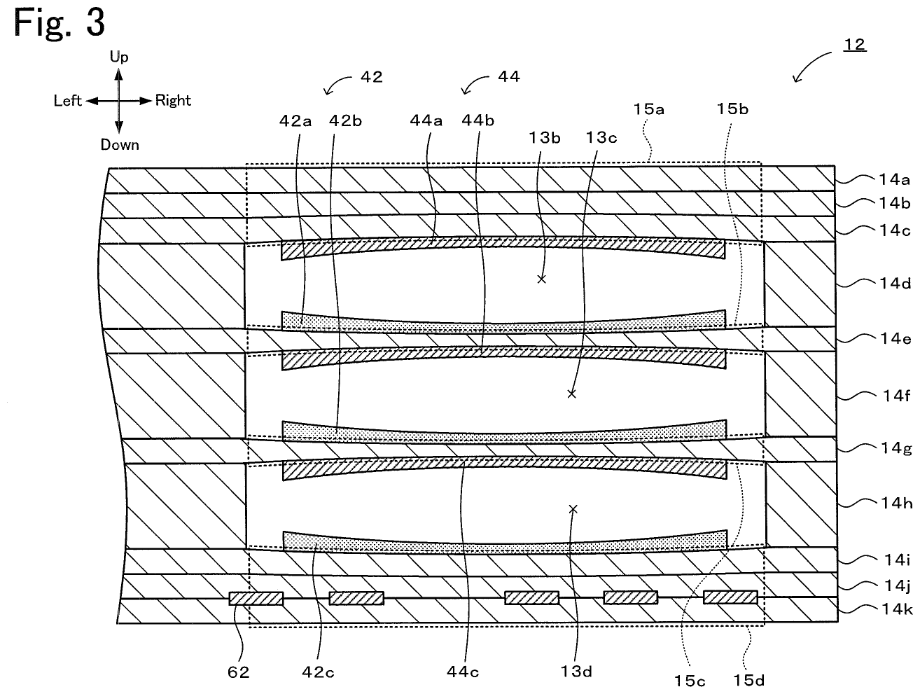

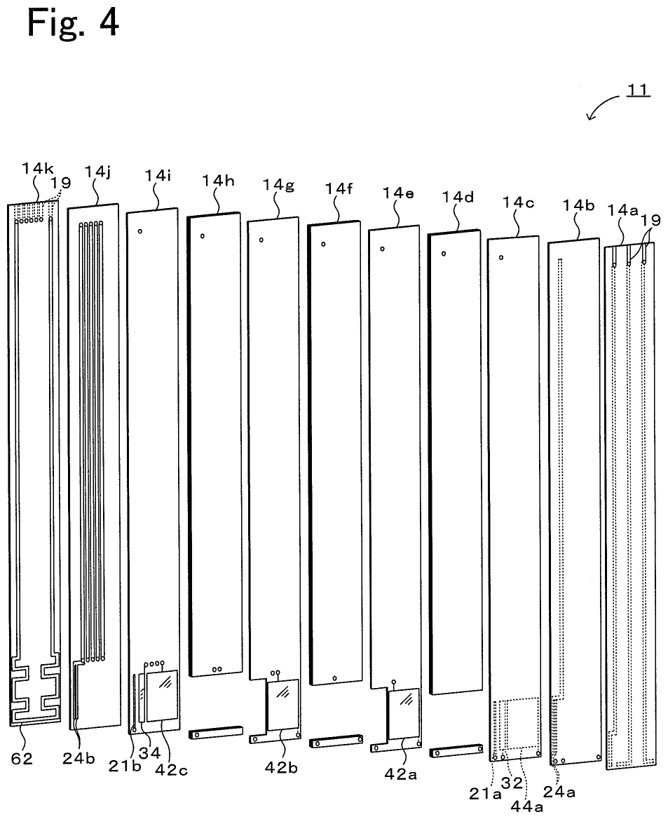

Next, an embodiment of the present invention will be described with reference to the drawings. FIG. 1 is a perspective view showing a schematic structure of a particle detector 10 that is an embodiment of the present invention. FIG. 2 is an A-A cross-sectional view of FIG. 1, and FIG. 3 is a partial cross-sectional view of a B-B cross section of FIG. 1. FIG. 4 is an exploded perspective view of a particle detection element 11. In the present embodiment, upward and downward directions, left and right directions, and forward and backward directions are as shown in FIGS. 1 to 3.

The particle detector 10 counts the number of particles 17 contained in a gas (for example, exhaust gas from an automobile). As shown in FIGS. 1 and 2, the particle detector 10 includes the particle detection element 11. As shown in FIG. 2, the particle detector 10 includes a discharge power source 29, a removal power source 39, a collection power source 49, a detector 50, and a heater power source 69. As shown in FIG. 2, the particle detection element 11 includes a casing 12, an electric charge generator 20, an excess electric charge removing unit 30, a collector 40, and a heater 60.

The casing 12 has therein a gas flow passage 13 through which gas passes. As shown in FIG. 2, the gas flow passage 13 includes: a gas inlet 13a for introducing the gas into the casing 12; and a plurality of (three in this case) branched flow passages 13b to 13d which are located downstream of the gas introduction port 13a and through which branched gas flows pass. The gas introduced into the casing 12 from the gas inlet 13a is discharged from the casing 12 through the branched flow passages 13b to 13d. A cross section of the gas flow passage 13 that is perpendicular to the center axis of the gas flow passage 13 (a cross section in the vertical and left-right directions) has a substantially rectangular shape. Cross sections of the gas inlet 13a and the branched flow passages 13b to 13d that are perpendicular to the center axis of the gas flow passage 13 have a substantially rectangular shape. As shown in FIGS. 1 and 4, the casing 12 has an elongated substantially cuboidal shape. As shown in FIGS. 2 to 4, the casing 12 is formed as a layered body in which a plurality of layers (first to eleventh layers 14a to 14k in this case) are stacked in a prescribed stacking direction (a vertical direction in this case). The casing 12 is an insulator and is made of a ceramic such as alumina. Through holes or notches are provided in the fourth to eighth layers 14d to 14h so as to pass therethrough in their thickness direction (in the vertical direction in this case), and the through holes or the notches serve as the gas flow passage 13. As shown in FIG. 3, the fourth, sixth, and eighth layers 14d, 14f, and 14h form the side walls (the left and right walls in this case) of the branched flow passages 13b, 13c, and 13d, respectively. In the present embodiment, the fourth, sixth, and eighth layers 14d, 14f, and 14h are thicker than other layers. The fourth, sixth, and eighth layers 14d, 14f, and 14h may each be a layered body including a plurality of layers.

As shown in FIGS. 2 and 3, the casing 12 has first to fourth walls 15a to 15d which face the gas flow passage 13 and on which at least one of a collecting electrode 42 and an electric field generating electrode 44 is disposed. The first wall 15a includes portions of the first to third layers 14a to 14c that are located directly above the gas flow passage 13. The lower surface of the first wall 15a forms a ceiling surface of the gas flow passage 13. The first wall 15a is a part of the upper outer wall of the casing 12. A discharge electrode 21a, an application electrode 32, and a first electric field generating electrode 44a are disposed on the lower surface of the first wall 15a. The second wall 15b includes a portion of the fifth layer 14e that faces the gas flow passage 13 (a portion located directly below the branched flow passage 13b and directly above the branched flow passage 13c). The second wall 15b is formed as a partition that vertically separates the branched flow passage 13b and the branched flow passage 13c from each other. A first collecting electrode 42a is disposed on the upper surface of the second wall 15b, and a second electric field generating electrode 44b is disposed on the lower surface. The third wall 15c includes a portion of the seventh layer 14g that faces the gas flow passage 13 (a portion located directly below the branched flow passage 13c and directly above the branched flow passage 13d). The third wall 15c is formed as a partition that vertically separates the branched flow passage 13c and the branched flow passage 13d from each other. A second collecting electrode 42b is disposed on the upper surface of the third wall 15c, and a third electric field generating electrode 44c is disposed on the lower surface. The fourth wall 15d includes portions of the ninth to eleventh layers 14i to 14k that are located directly below the gas flow passage 13. The upper surface of the fourth wall 15d forms the bottom surface of the gas flow passage 13. The fourth wall 15d is part of the lower outer wall of the casing 12. A discharge electrode 21b, a removing electrode 34, and a third collecting electrode 44c are disposed on the upper surface of the fourth wall 15d.

As shown in FIG. 3, in the first to fourth walls 15a to 15d, their cross sections perpendicular to the center axis of the gas flow passage 13 have a shape having a central portion (a central portion in the left-right direction in this case) thinner than other portions. In the following description, such a shape is referred to as a thin-central wall shape. The first to fourth walls 15a to 15d each have a shape whose thickness gradually decreases toward the center in the left-right direction. In each of the first to fourth walls 15a to 15d, portions of the upper and lower surfaces that face the gas flow passage 13 are curved surfaces, and the thin-central wall shape is thereby formed. The thin-central wall shape may be a shape whose minimum thickness is less than 96% of the maximum thickness. The thin-central wall shape may be a shape whose minimum thickness is 50 μm or more.

In each of the first to fourth walls 15a to 15d, the thickness of the central portion in any cross section perpendicular to the center axis of the gas flow passage 13 is smaller than the thickness of other portions. Therefore, connection wall portions 70a and 70b that are shown in FIG. 2 and are portions of the first wall 15a and connection wall portions 70c and 70d that are shown in FIG. 2 and are portions of the fourth wall 15d are each formed to have the thin-central wall shape in which a portion facing the gas flow passage 13 is curved, as in the shape shown in FIG. 3. The connection wall portion 70a has a connection surface 72a that is part of the inner circumferential surface of the casing 12 exposed to the flow passage 13 and connects the discharge electrode 21a to the application electrode 32 in the front-back direction. Similarly, the connection wall portion 70b has a connection surface 72b that is part of the inner circumferential surface of the casing 12 and connects the application electrode 32 to the first electric field generating electrode 44a in the front-back direction. The connection wall portion 70c has a connection surface 74c that is part of the inner circumferential surface of the casing 12 and connects the discharge electrode 21b to the removing electrode 34 in the front-back direction. The connection wall portion 70d has a connection surface 72d that is part of the inner circumferential surface of the casing 12 and connects the removing electrode 34 to the third collecting electrode 44c in the front-back direction. The connection surfaces 72a and 72b are the lower surfaces of the connection wall portions 70a and 70b, respectively, and the connection surfaces 74c and 72d are the upper surfaces of the connection wall portions 70c and 70d, respectively. The connection surfaces 72a to 72d are surfaces that can act as a short circuit path between electrodes when conductive particles 17 adhere to the surfaces. For example, the connection surface 72a can act as a short circuit path between the discharge electrode 21a and the application electrode 32.

As shown in FIG. 2, the electric charge generator 20 includes first and second electric charge generators 20a and 20b disposed in the casing 12 on the side close to the gas inlet 13a. The first electric charge generator 20a includes the discharge electrode 21a disposed on the first wall 15a and ground electrodes 24a disposed in the first wall 15a. The discharge electrode 21a and the ground electrodes 24a are disposed on the front and back sides, respectively, of the third layer 14c serving as a dielectric layer. The discharge electrode 21a is disposed on the lower surface of the first wall 15a and exposed to the gas flow passage 13. The second electric charge generator 20b includes the discharge electrode 21b disposed on the fourth wall 15d and ground electrodes 24b disposed in the fourth wall 15d. The discharge electrode 21b and the ground electrodes 24b are disposed on the front and back sides, respectively, of the ninth layer 14i serving as a dielectric layer. The discharge electrode 21b is disposed on the upper surface of the fourth wall 15d and exposed to the gas flow passage 13. Each of the discharge electrodes 21a and 21b is formed from a rectangular thin metal plate with a plurality of fine triangular projections 22 on its opposed long sides (see FIG. 1). Each of the ground electrodes 24a and 24b is a rectangular electrode, and two ground electrodes 24a and two ground electrodes 24b are disposed parallel to the longitudinal direction of the discharge electrodes 21a and 21b. The discharge electrodes 21a and 21b and the ground electrodes 24a and 24b are connected to the discharge power source 29. The ground electrodes 24a and 24b are connected to the ground.

In the first electric charge generator 20a, when a high high-frequency voltage (e.g., a pulse voltage etc.) is applied between the discharge electrode 21a and the ground electrodes 24a from the discharge power source 29, an aerial discharge (dielectric barrier discharge in this case) occurs in the vicinity of the discharge electrode 21a due to the potential difference between the electrodes. Similarly, in the second electric charge generator 20b, an aerial discharge occurs in the vicinity of the discharge electrode 21b due to the potential difference between the discharge electrode 21b and the ground electrodes 24b caused by a high voltage from the discharge power source 29. Gas present around the discharge electrodes 21a and 21b is thereby ionized by these discharges, and charges 18 (positive charges in this case) are generated. The charges 18 are imparted to the particles 17 in the gas passing through the electric charge generator 20, and charged particles P are thereby formed (see FIG. 2).

The excess electric charge removing unit 30 includes the application electrode 32 and the removing electrode 34. The application electrode 32 and the removing electrode 34 are located downstream of the electric charge generator 20 but upstream of the collector 40. The application electrode 32 is disposed on the lower surface of the first wall 15a and exposed to the gas flow passage 13. The removing electrode 34 is disposed on the upper surface of the fourth wall 15d and exposed to the gas flow passage 13. The application electrode 32 and the removing electrode 34 are disposed in positions facing each other. The application electrode 32 is an electrode to which a small positive potential V2 is applied from the removal power source 39. The removing electrode 34 is an electrode connected to the ground. In this case, a weak electric field is generated between the application electrode 32 and the removing electrode 34 of the excess electric charge removing unit 30. Therefore, among the charges 18 generated by the electric charge generator 20, excess charges 18 not imparted to the particles 17 are attracted to the removing electrode 34 by this weak electric field, captured by the removing electrode 34, and discarded to the ground. In this manner, the excess electric charge removing unit 30 prevents the excess charges 18 from being collected by the collecting electrodes 42 of the collector 40 and counted as the particles 17.

The collector 40 is a device for collecting a collection target (the charged particles P in this case) and is disposed in the branched flow passages 13b to 13d located downstream of the electric charge generator 20 and the excess electric charge removing unit 30. The collector 40 includes one or more collecting electrodes 42 for collecting the charged particles P and one or more electric field generating electrodes 44 for causing the charged particles P to move toward the collecting electrodes 42. In the present embodiment, the collector 40 includes first to third collecting electrodes 42a to 44c as the collecting electrodes 42 and first to third electric field generating electrodes 44a to 44c as the electric field generating electrodes 44. The first electric field generating electrode 44a is disposed on the lower surface of the first wall 15a, and the first collecting electrode 42a is disposed on the upper surface of the second wall 15b. The first electric field generating electrode 44a and the first collecting electrode 42a are disposed at positions facing each other vertically and are each exposed to the branched flow passage 13b. The second electric field generating electrode 44b is disposed on the lower surface of the second wall 15b, and the second collecting electrode 42b is disposed on the upper surface of the third wall 15c. The second electric field generating electrode 44b and the second collecting electrode 42b are disposed at positions facing each other vertically and are each exposed to the branched flow passage 13c. The third electric field generating electrode 44c is disposed on the lower surface of the third wall 15c, and the third collecting electrode 44c is disposed on the upper surface of the fourth wall 15d. The third electric field generating electrode 44c and the third collecting electrode 44c are disposed at positions facing each other vertically and are each exposed to the branched flow passage 13d. A voltage V1 is applied from the collection power source 49 to the first to third electric field generating electrodes 44a to 44c. The first to third collecting electrodes 42a to 44c are each connected to the ground through an ammeter 52. In this case, an electric field directed from the first electric field generating electrode 44a toward the first collecting electrode 42a is generated in the branched flow passage 13b, and an electric field directed from the second electric field generating electrode 42b toward the second collecting electrode 42b is generated in the branched flow passage 13c. Moreover, an electric field directed from the third electric field generating electrode 44c toward the third collecting electrode 44c is generated in the branched flow passage 13d. Therefore, the charged particles P flowing through the gas flow passage 13 enter any of the branched flow passages 13b to 13d, are moved downward by the electric field generated therein, attracted to any of the first to third collecting electrodes 42a to 44c, and collected thereby. The voltage V1 is a positive potential, and the level of the voltage V1 is of the order of, for example, 100 V to several kV. The sizes of the electrodes 34 and 42 and the strengths of the electric fields (i.e., the magnitudes of the voltages V1 and V2) on the electrodes 34 and 42 are set such that the charged particles P are collected by the collecting electrodes 42 without being collected by the removing electrode 34 and that the charges 17 not adhering to the particles 18 are collected by the removing electrode 34.

The first to third collecting electrodes 42a to 44c and the first to third electric field generating electrodes 44a to 44c each have the thin-central wall shape, as do the first to fourth walls 15a to 15d. Specifically, as shown in FIG. 3, the collecting electrodes 42 and the electric field generating electrodes 44 each have a shape whose thickness in a cross section perpendicular to the center axis of the gas flow passage 13 is smaller in a central portion (a portion located at the center, with respect to the left-right direction, of one of the branched flow passages 13b to 13d) than in other portions. The collecting electrodes 42 and the electric field generating electrodes 44 each have a shape whose thickness gradually decreases toward the central portion. In each of the first to fourth walls 15a to 15d, portions of the upper and lower surfaces that face the gas flow passage 13 (the branched flow passages 13b to 13d in this case) are curved surfaces, and the thin-central wall shape is thereby formed.

The detector 50 includes the ammeter 52 and an arithmetic unit 54. One terminal of the ammeter 52 is connected to the collecting electrodes 42, and the other terminal is connected to the ground. The ammeter 52 measures a current based on the charges 18 on the charged particles P collected by the collecting electrodes 42. The arithmetic unit 54 computes the number of particles 17 based on the current measured by the ammeter 52. The arithmetic unit 54 may function as a control unit that controls the units 20, 30, 40, and 60 by controlling on/off of each of the power sources 29, 39, 49, and 69 and their voltages.

The heater 60 includes a heater electrode 62 disposed between the tenth layer 14i and the eleventh layer 14k and embedded in the fourth wall 15d. The heater electrode 62 is, for example, a band-shaped heating element routed in a zigzag pattern. The heater electrode 62 is disposed so as to be present at least directly below the third collecting electrode 44c. In the present embodiment, the heater electrode 62 is routed over almost the entire region directly below the gas flow passage 13 and is present also below the discharge electrode 21b and the removing electrode 34. The heater electrode 62 is connected to the heater power source 69 and generates heat when energized by the heater power source 69. The heat generated by the heater electrode 62 transfers to the electrodes such as the collecting electrodes 42 and the casing 12 by heat conduction through the casing 12, radiation through the gas flow passage 13, etc. to thereby heat these electrodes and the inner circumferential surface of the casing 12.

As shown in FIGS. 1 and 4, a plurality of terminals 19 are disposed on the upper and lower surfaces of the left end of the casing 12. The above-described electrodes 21a, 21b, 24a, 24b, 32, 34, 42, and 44 are electrically connected to their respective terminals 19 through wiring lines disposed in the casing 12. Similarly, the heater electrode 62 is electrically connected to two terminals 19 through wiring lines. For example, the wiring lines are disposed on the upper and lower surfaces of the first to eleventh layers 14a to 14k or disposed in through holes provided in the first to eleventh layers 14a to 14k. Although not illustrated in FIG. 2, the power sources 29, 39, 49, and 69 and the ammeter 52 are electrically connected to the respective electrodes in the particle detection element 11 through the terminals 19.

A method for producing the thus-configured particle detection element 11 will be described below. First, a plurality of unfired ceramic green sheets containing a ceramic raw material powder and corresponding to the first to eleventh layers 14a to 14k are prepared. Through holes and a space serving as the gas flow passage 13 are formed by, for example, punching in advance in each of the green sheets corresponding to the fourth to eighth layers 14d to 14h. Next, pattern printing processing for forming various patterns on the ceramic green sheets corresponding to the first to eleventh layers 14a to 14k and drying processing are performed. Specifically, the patterns to be formed are, for example, patterns for the electrodes, the wiring lines connected to the electrodes, the terminals 19, etc. The patterns are printed by applying a pattern forming paste to the green sheets using a known screen printing technique. During, before, and after the pattern printing processing, the through holes are filled with a conductive paste that later becomes wiring lines. Subsequently, printing processing for printing a bonding paste for laminating and bonding the green sheets and drying processing are performed. The green sheets with the bonding paste formed thereon are stacked in a prescribed order, and compression-bonding processing for forming one layered body is performed. Specifically, prescribed temperature-pressure conditions are applied to compression-bond the green sheets. When the compression-bonding processing is performed, a vanishing material (e.g., theobromine) that vanishes during firing is filled into the space that later becomes the gas flow passage 13 in advance. Then the layered body is cut to obtain a layered body having the size of the casing 12. Then the cut layered body is fired at a prescribed firing temperature. Since the vanishing material vanishes during firing, the portion filled with the vanishing material forms the gas flow passage 13. The particle detection element 11 is thereby obtained.

In the process of producing the particle detection element 11, the first to fourth walls 15a to 15d having the thin-central wall shape, the collecting electrodes 42, and the electric field generating electrodes 44 can be formed as follows. For example, the thickness of the vanishing material filled during the above-described compression-bonding processing is adjusted such that the thickness of the vanishing material in central portions, with respect to the left-right direction, in the space that later becomes the gas flow passage 13 is increased. In this case, when pressure is applied to the plurality of stacked green sheets, the central portions, with respect to the left-right direction, of portions that later become the first to fourth walls 15a to 15d, the collecting electrodes 42, and the electric field generating electrodes 44 are pressed more strongly than other portions and recessed and formed into the thin-central wall shape. Alternatively, the green sheets may be formed using molds such that the first to fourth walls 15a to 15d have the thin-central wall shape. Alternatively, when the patterns for the collecting electrodes 42 and the electric field generating electrodes 44 are formed, the number of times printing is performed on portions other than the central portions may be increased to adjust the thicknesses of the patterns such that the electrodes are formed into the thin-central wall shape.

The casing 12 formed of the ceramic material described above is preferable because the following effects are obtained. Generally, the ceramic material has high heat resistance and can easily withstand the temperature at which the particles 17 are removed using the heater electrode 62 as described later, e.g., a high temperature of 600° C. to 800° C. at which carbon, which is the main component of the particles 17, burns. Moreover, since the ceramic material generally has a high Young's modulus, the stiffness of the casing 12 can be easily maintained even when the walls and partitions of the casing 12 are thin, and therefore the deformation of the casing 12 caused by a thermal shock or an external force can be prevented. Since the deformation of the casing 12 is prevented, a reduction in the accuracy of detection of the number of particles due to, for example, a change in the electric field distribution in the gas flow passage 13 during discharge of the electric charge generator 20 or a change in the thicknesses (vertical heights) of the branched flow passages 13b to 13d can be prevented. Therefore, by forming the casing 12 using the ceramic material, the thicknesses of the walls and partitions of the casing 12 can be reduced to make the casing 12 more compact while the deformation of the casing 12 is prevented. No particular limitation is imposed on the ceramic material. Examples of the ceramic material include alumina, silicon nitride, mullite, cordierite, magnesia, and zirconia.

Next, an example of the use of the particle detector 10 will be described. When particles contained in exhaust gas from an automobile is measured, the particle detection element 11 is installed inside the exhaust pipe of the engine. In this case, the particle detection element 11 is installed such that the exhaust gas is introduced into the casing 12 from the gas inlet 13a, passes through the branched flow passages 13b to 13d, and is then discharged. The power sources 29, 39, 49, and 69 and the detector 50 are connected to the particle detection element 11.

The particles 17 contained in the exhaust gas introduced into the casing 12 from the gas inlet 13a are charged by the charges 18 (positive charges in this case) generated by discharge in the electric charge generator 20 and form charged particles P. In the excess electric charge removing unit 30, the electric field is weak, and the length of the removing electrode 34 is shorter than the length of the collecting electrodes 42. Therefore, the charged particles P pass through the excess electric charge removing unit 30 without any change, flow into any of the branched flow passages 13b to 13d, and reach the collector 40. The charges 18 not imparted to the particles 17 are attracted to the removing electrode 34 of the excess electric charge removing unit 30 even though the electric field is weak and are discarded to the GND through the removing electrode 34. Therefore, almost no unnecessary charges 18 not imparted to the particles 17 reach the collector 40.

The charged particles P that have reached the collector 40 are collected by any of the first to third collecting electrodes 42a to 44c through the electric field generated by the electric field generating electrodes 44. A current corresponding to the charges 18 on the charged particles P adhering to the collecting electrodes 42 is measured by the ammeter 52, and the arithmetic unit 54 computes the number of particles 17 based on the current. In the present embodiment, the first to third collecting electrodes 42a to 44c are connected to one ammeter 52, and the current corresponding to the total number of charges 18 on the charged particles P adhering to the first to third collecting electrodes 42a to 44c is measured by the ammeter 52. The relation between the current I and the amount of charges q is I=dq/(dt), q=∫Idt. The arithmetic unit 54 integrates (accumulates) the current value over a prescribed period to obtain the integrated value (accumulated charge amount), divides the accumulated charge amount by the elementary charge to determine the total number of charges (the number of collected charges), and divides the number of collected charges by the average number of charges (average charge number) imparted to one particle 17 to determine the number Nt of particles 17 adhering to the collecting electrodes 42. The arithmetic unit 54 detects the number Nt as the number of particles 17 in the exhaust gas. However, part of the particles 17 may pass through without being collected by the collecting electrodes 42 or may adhere to the inner circumferential surface of the casing 12 before collected by the collecting electrodes 42. Therefore, the collection ratio of particles 17 may be determined in advance in consideration of the ratio of particles 17 not collected by the collecting electrodes 42, and the arithmetic unit 54 may detect the total number Na, which is the value obtained by dividing the number Nt by the collection ratio, as the number of particles 17 in the exhaust gas.

When a large number of particles 17 etc. accumulate on the collecting electrodes 42, additional charged particles P may no longer be collected by the collecting electrodes 42. Therefore, by heating the collecting electrodes 42 by the heater electrode 62 periodically or at the time when the amount of accumulation reaches a prescribed amount, the accumulated materials on the collecting electrodes 42 are heated by the heater electrode 62 to incinerate the accumulated materials to thereby refresh the electrode surfaces of the collecting electrodes 42.

The concentration of the particles 17 in the exhaust gas tends to be higher in a region close to the center axis of the gas flow passage 13 in the casing 12. Therefore, the particles 17 are more likely to adhere to portions of the collecting electrodes 42 that are close to the center axis of the gas flow passage 13. For example, in the branched flow passage 13b, the concentration of the particles 17 tends to be higher in a region close to the center axis of the branched flow passage 13b in the cross section shown in FIG. 3, i.e., a region close to the center with respect to the vertical and horizontal directions. Therefore, the particles 17 are more likely to adhere to a portion of the first collecting electrode 42a that is close to the center axis of the branched flow passage 13b, i.e., to a portion of the first collecting electrode 42a that is located at the horizontal center of the branched flow passage 13b than to other portions. Similarly, in the second collecting electrode 42b and the third collecting electrode 44c, the particles 17 are more likely to adhere to portions located at the horizontal centers of the branched flow passages 13c and 13d. In the particle detection element 11 in the present embodiment, the second to fourth walls 15b to 15d, which are collecting electrode-disposed walls of the casing 12 on which the respective collecting electrodes 42 are disposed, have the thin-central wall shape whose thickness in a cross section perpendicular to the center axis of the gas flow passage 13 is smaller in the central portion than in other potions. Therefore, in the second to fourth walls 15b to 15d having the thin-central wall shape, the central portions have a smaller heat capacity than the other portions, and the temperature of the central portions are more likely to increase. In this case, when the heater 60 heats the particles 17 adhering to the first to third collecting electrodes 42a to 44c, the temperature of portions of the first to third collecting electrodes 42a to 44c to which the particles 17 are more likely to adhere (the temperature of the portions close to the center axis of the gas flow passage 13) is more likely to increase. Therefore, in the first to third collecting electrodes 42a to 44c, the particles 17 can be burnt by quickly increasing the temperature of the portions to which a large number of particles 17 adhere. The particles 17 adhering to the collecting electrodes 42 can be removed in a shorter time. During a period of time during which the particles 17 are burnt by the heater 60, the arithmetic unit 54 cannot detect the number of particles 17 (this period is referred to as dead time). However, in the particle detection element 11 in the present embodiment, the dead time can be shortened.

The particles 17 adhere to and accumulate on the collecting electrodes 42. Moreover, the particles 17 may adhere to and accumulate also on electrodes exposed to the gas flow passage 13 (the discharge electrodes 21a and 21b, the application electrode 32, the removing electrode 34, and the electric field generating electrodes 44 in this case). When the electrode surfaces of the collecting electrodes 42 are refreshed by the heater 60, particles 17 adhering to at least one of the above electrodes may be burnt to refresh the electrode surface. In this case, in each of the first to fourth walls 15a to 15d, the central portion is thinner than other portions in any cross section perpendicular to the center axis of the gas flow passage 13. Therefore, when the particles 17 adhering to electrodes other than the collecting electrodes 42 are removed, as in the case when the particles 17 adhering to the collecting electrodes 42 are removed, the temperature of portions of these electrodes to which a large number of particles 17 adhere can be increased quickly to burn the particles 17.

The correspondence between the components in the present embodiment and the components in the present invention will be explained. The casing 12 in the present embodiment corresponds to the casing in the present invention, and the electric charge generator 20 corresponds to the electric charge generating unit. The collector 40 corresponds to the collecting unit, and the heater 60 corresponds to the heating unit. The second to fourth walls 15b to 15d correspond to the collecting electrode-disposed walls, and the first to third walls 15a to 15c correspond to the electric field generating electrode-disposed walls. The discharge electrodes 21a and 21b, the application electrode 32, the removing electrode 34, the collecting electrodes 42, and the electric field generating electrodes 44 correspond to the exposed electrodes, and the detector 50 corresponds to the detection unit.

In the particle detection element 11 in the present embodiment described above in detail, each of the second to fourth walls 15b to 15d of the casing 12, which are the collecting electrode-disposed walls on which the respective collecting electrodes 42 are disposed, has the thin-central wall shape. Therefore, in each of the second to fourth walls 15b to 15d, the central portion with respect to the left-right direction has a smaller heat capacity than other portions, and the temperature of the central portion is more likely to increase. In this case, in the particle detection element 11, the temperature of the portions of the collecting electrodes 42 to which a large number of particles 17 adhere, i.e., the temperature of the portions of the first to third collecting electrodes 42a to 44c that are close to the center axis of the gas flow passage 13, can be increased quickly by the heater 60 to burn the particles 17. This allows the particles 17 adhering to the first to third collecting electrodes 42a to 44c to be removed in a shorter time. The entire second to fourth walls 15b to 15d may be thinned to reduce their heat capacities. However, in this case, the strength of the casing 12 tends to decrease. When the second to fourth walls 15b to 15d have the thin-central wall shape, the particles 17 adhering to the collecting electrodes 42 can be removed in a short time while a reduction in strength of the casing 12 is prevented. When the second to fourth walls 15b to 15d have the thin-central wall shape, the central portions can be heated more intensively than when the entire second to fourth walls 15b to 15d are thinned.

The casing 12 has the second and third walls 15b and 15c serving as partitions that partition the gas flow passage 13. The structure in which the partitions provided are used to partition the gas flow passage 13 has the effects described below. Consider a structure with the second and third walls 15b and 15c in FIG. 2 removed as a comparative example. In this structure, the charged particles P receive a repulsive or attractive force only through the electric field generated between the first electric field generating electrode 44a and the third collecting electrode 44c. In this case, to collect approximately the same number of particle as those in the above embodiment, the voltage applied to the first electric field generating electrode 44a must be about three times the voltage V1 in the above embodiment (3V1) (the thicknesses of the second wall 15b and the third wall 15c are assumed to be sufficiently smaller than the thickness of the gas flow passage 13). Specifically, by providing the partitions, the voltage applied can be reduced. This allows the reliability of the collection power source 49 to be improved, and a short circuit between the terminals 19 disposed in the particle detection element 11 in order to apply the voltage V1 can be prevented.

The second to fourth walls 15b to 15d, which are the collecting electrode-disposed walls having the thin-central wall shape, each have a shape whose thickness in a cross section perpendicular to the center axis of the gas flow passage 13 gradually decreases toward the central portion of the gas flow passage 13. Therefore, the strength of the second to fourth walls 15b to 15d tends to be higher than that when, for example, the second to fourth walls 15b to 15d have a thin-central wall shape having a step portion at which the thickness changes abruptly.

Moreover, since the first to third collecting electrodes 42a to 44c each have the thin-central wall shape, the heat capacity of a portion of each electrode that is located at the central portion, with respect to the left-right direction, of the gas flow passage 13 is reduced. Therefore, the temperature of the portions of the first to third collecting electrodes 42a to 44c to which the particles 17 are more likely to adhere is more likely to increase, and the particles 17 adhering to the first to third collecting electrodes 42a to 44c can be removed in a shorter time. Since the first to third collecting electrodes 42a to 44c have the thin-central wall shape, the surface area of the upper surface of each electrode is larger than that when the electrode has a shape with a constant thickness. Therefore, for each of the first to third collecting electrodes 42a to 44c, the allowable accumulation amount of particles 17 increases. This can prevent a state in which additional charged particles P are no longer collected by the collecting electrodes 42 and can increase the time interval during which the heater 60 for refreshing the electrode surfaces of the collecting electrodes 42 is not used.

Moreover, the casing 12 has the first to third walls 15a to 15c that are the electric field generating electrode-disposed walls on which the respective electric field generating electrodes 44 are disposed, and the first to third walls 15a to 15c each have the thin-central wall shape. Therefore, in the first to third electric field generating electrodes 44a to 44c disposed on the first to third walls 15a to 15c, as in the first to third collecting electrodes 42a to 44c disposed on the second to fourth walls 15b to 15d having the thin-central wall shape, the temperature of the portions to which a large number of particles 17 adhere can be increased rapidly to burn the particles 17. Moreover, since the first to third electric field generating electrodes 44a to 44c each have the thin-central wall shape, the heat capacities of the portions of these electrodes that are located at the center, with respect to the left-right direction, of the gas flow passage 13 are also small, and the particles 17 adhering to these electrodes can be removed in a shorter time.

Moreover, the particle detection element 11 includes a plurality of exposed electrodes exposed to the gas flow passage 13 (the discharge electrodes 21a and 21b, the application electrode 32, the removing electrode 34, the collecting electrodes 42, and the electric field generating electrodes 44 in this case). The casing 12 has the connection wall portion 70a having the thin-central wall shape and having the connection surface 72a that is part of the inner circumferential surface exposed to the gas flow passage 13 and is a portion connecting at least two of the plurality of exposed electrodes to each other. Similarly, the casing 12 has the connection wall portions 70b to 70d having the thin-central wall shape and having the respective connection surfaces 72b to 72d. The heater 60 heats the connection wall portions 70a to 70d. During the use of the particle detection element 11, part of the particles 17 may gradually adhere to the inner circumferential surface of the casing 12. Generally, the particles 17 are often formed of conductive materials such as carbon. Therefore, when a large number of particles 17 adhere to the inner circumferential surface of the casing 12, the particles 17 may form a short circuit path along the inner circumferential surface of the casing 12, and the electrodes exposed at the inner circumferential surface may be short-circuited. However, the heater 60 can remove particles adhering to the connection surfaces 72a to 72d between the exposed electrodes by heating the connection wall portions 70a to 70d. Moreover, in the connection wall portions 70a to 70d having the thin-central wall shape, portions located at the center of the gas flow passage 13 have a small heat capacity. Therefore, on the connection surfaces 72a to 72d of the connection wall portions 70a to 70d, the temperature of the portions to which the particles 17 are more likely to adhere is more likely to increase. Since the connection wall portions 70a to 70d have the thin-central wall shape, the particles 17 adhering to the connection surfaces 72a to 72d can be removed by the heater 60 in a shorter time. Therefore, the particle detection element 11 can prevent, for example, the formation of a short circuit path. Even if a short circuit path is formed, the particle detection element 11 can quickly recover from the short circuited state. Since the particle detection element 11 can quickly recover from the short-circuited state, the response failure time of the particle detection element 11 (the period of time during which the number of particles 17 cannot be detected) can be shortened.

Moreover, the casing 12 is an insulator (dielectric), and the electric charge generator 20 includes the discharge electrodes 21a and 21b exposed to the gas flow passage 13 and the ground electrodes 24a and 24b embedded in the casing 12. Therefore, portions of the casing 12 that are sandwiched between the discharge electrodes 21a and 21b and the ground electrodes 24a and 24b serve as dielectric layers. The electric charge generator 20 can generate charges 18 through a dielectric barrier discharge that occurs in the vicinities of the discharge electrodes 21a and 21b, and the particles 17 can thereby be converted to charged particles P. Therefore, the amount of charges 18 equivalent to the amount of charges 18 generated by a corona discharge using, for example, needle-shaped discharge electrodes can be obtained at a lower voltage and lower power consumption. Since the ground electrodes 24a and 24b are embedded in the casing 12, the ground electrodes 24a and 24b can be prevented from being short-circuited with other electrodes. Moreover, since the discharge electrodes 21a and 21b each have the plurality of projections 22, the charges 18 can be generated at a higher concentration. The discharge electrodes 21a and 21b are disposed along the inner circumferential surface of the casing 12 that is exposed to the gas flow passage 13. Therefore, the discharge electrodes 21a and 21b can be integrally formed with the casing 12 more easily than when, for example, needle-shaped discharge electrodes are disposed so as to exposed to the gas flow passage 13. Moreover, the discharge electrodes 21a and 21b are less likely to block the flow of the gas, and particles are less likely to adhere to the discharge electrodes 21a and 21b.

The present invention is not limited to the above-described embodiments, and can be carried out by various modes as long as they belong to the technical scope of the invention.

For example, in the above embodiment, each of the first to third collecting electrodes 42a to 44c has the thin-central wall shape, but this is not a limitation. At least one of the first to third collecting electrodes 42a to 44c may have the thin-central wall shape, and all of them may not have the thin-central wall shape. This also applies to the electric field generating electrodes 44. Each of the electrodes exposed to the gas flow passage 13 (in the above embodiment, the discharge electrodes 21a and 21b, the application electrode 32, the removing electrode 34, the collecting electrodes 42, and the electric field generating electrodes 44) may have the thin-central wall shape.

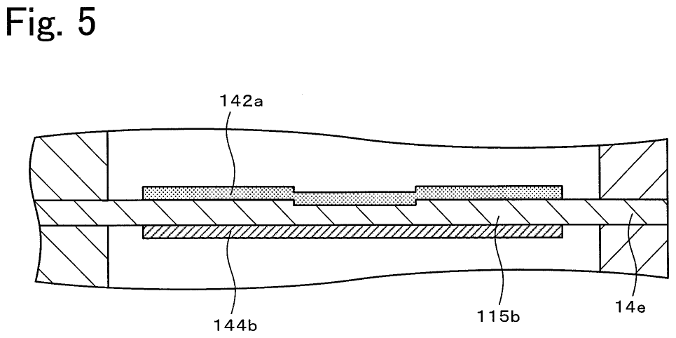

In the above embodiment, the walls and electrodes having the thin-central wall shape each have the shape whose thickness in a cross section perpendicular to the center axis of the gas flow passage 13 gradually decreases toward a central portion (a portion close to the center axis of the gas flow passage 13), but this is not a limitation. For example, a shape having steps, such as the shape of a second outer wall 115b in a modification shown in FIG. 5, may be used as the thin-central wall shape. In this case, since the thin-walled portion can be disposed only in the central portion, the central portion can be heated more intensively. The second outer wall 115b in FIG. 5 has the steps on the upper surface. However, it is only necessary that the steps be provided on at least one of the upper and lower surfaces. A first collecting electrode 142a in FIG. 5 has steps conforming to the steps of the second outer wall 115b, but the thickness of the first collecting electrode 142a is constant. However, the height of the steps of the first collecting electrode 142a may be increased to form a thin-central wall shape whose thickness is smaller in the central portion. Similarly, although a second electric field generating electrode 144b in FIG. 5 has a constant thickness, the second electric field generating electrode 144b may have a thin-central wall shape having steps.

In the above embodiment, the first to third walls 15a to 15c, which are the electric field generating electrode-disposed walls, each have the thin-central wall shape, but this is not a limitation. At least one of the first to third walls 15a to 15c may have the thin-central wall shape, or all of them may not have the thin-central wall shape.

In the above embodiment, the second to fourth walls 15b to 15d, which are the collecting electrode-disposed walls, each have the thin-central wall shape, but this is not a limitation. At least one of them may have the thin-central wall shape. For example, the third collecting electrode 44c among the plurality of collecting electrodes 42 that is closest to the heater electrode 62 is disposed on the fourth wall 15d among the second to fourth walls 15b to 15d, and the fourth wall 15d may not have the thin-central wall shape. Alternatively, the first collecting electrode 42a among the plurality of collecting electrodes 42 that is farthest from the heater electrode 62 is disposed on the second wall 15b among the second to fourth walls 15b to 15d, and at least the second wall 15b may have the thin-central wall shape.

In the above embodiment, in each of the first to fourth walls 15a to 15d, the thickness of the central portion is smaller than that of other portions in any cross section perpendicular to the center axis of the gas flow passage 13, but this is not a limitation. When the collecting electrode-disposed walls (for example, the second to fourth walls 15b to 15d) have the thin-central wall shape, each of them may have the thin-central wall shape in a cross section at least passing through the corresponding collecting electrode 42 disposed thereon and perpendicular to the center axis of the gas flow passage 13. However, when the collecting electrode-disposed walls have the thin-central wall shape, it is preferable that the thickness of the central portion of each of them is smaller than the thickness of other portions in any cross section passing through the corresponding collecting electrode 42 disposed thereon and perpendicular to the center axis of the gas flow passage 13. This also applies to the electric field generating electrode-disposed walls (for example, the first to third walls 15a to 15c).

In the above embodiment, the connection wall portions 70a to 70d are formed to have the thin-central wall shape, but this is not a limitation. When a connection wall portion having a connection surface connecting at least two of the plurality of exposed electrodes included in the particle detection element 11 has the thin-central wall shape, effects such as prevention of the formation of a short circuit path between the two electrodes and rapid recovery from a short-circuited state can be obtained. For example, a portion of the fourth layer 14d that is located on the right side of the branched flow passage 13b in FIG. 3 is a right side wall having the right side surface of the branched flow passage 13b. When the right side surface has a thin-central wall shape (a shape whose thickness is smaller in the central portion with respect to the vertical direction than other portions), the above effects can be obtained in a portion between the first electric field generating electrode 44a and the first collecting electrode 42a.

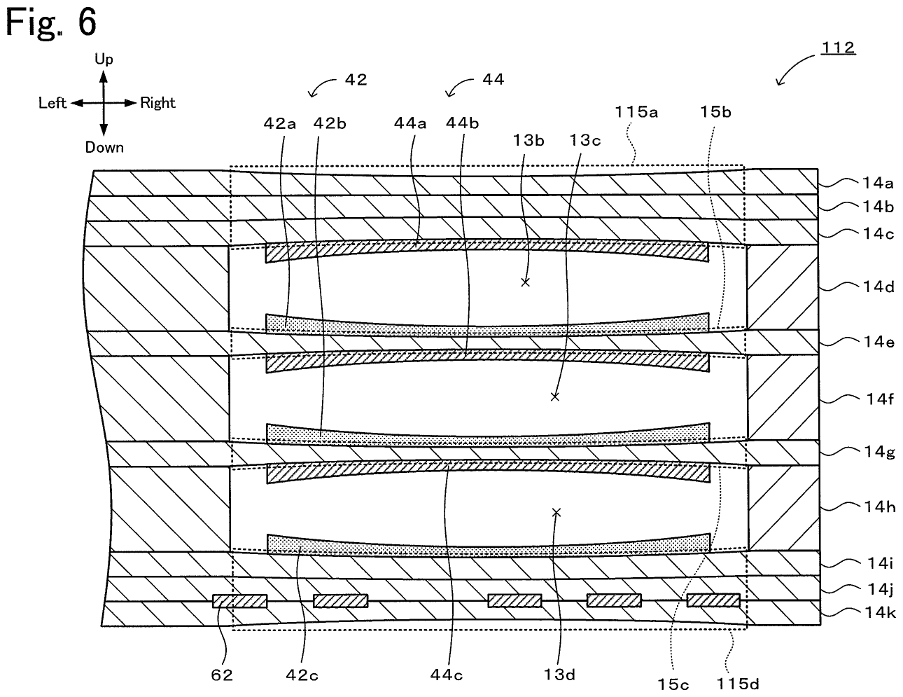

In the above embodiment, in each of the first to fourth walls 15a to 15d, portions of the upper and lower surfaces that face the gas flow passage 13 are curved surfaces, but this is not a limitation. For example, in each of the first and fourth walls 15a and 15d, which serves as outer walls, at least one of a portion facing the gas flow passage 13 and the outer surface may be curved. FIG. 6 is a partial cross-sectional view of a casing 112 in a modification in the above case. In first and fourth walls 115a and 115b in FIG. 6, both a portion facing the gas flow passage 13 and the outer surface are curved. Each of the second and third walls 15b and 15c serving as partitions has two portions facing the gas flow passage 13, and one of them may not be curved.

In the above embodiment, the electric field generating electrodes 44 are exposed to the gas flow passage 13, but this is not a limitation. The electric field generating electrodes 44 may be embedded in the casing 12. In this case, the electric field generating electrode-disposed walls and the electric field generating electrodes 44 need not have the thin-central wall shape. Instead of the first electric field generating electrode 44a, a pair of electric field generating electrodes may be provided in the casing 12 so as to vertically sandwich the first collecting electrode 42a therebetween, and the charged particles P may be moved toward the first collecting electrode 42a through an electric field generated by a voltage applied between the pair of electric field generating electrodes. This also applies to the second to third electric field generating electrodes 44b to 44c.

In the above embodiment, one collecting electrode 42 is disposed on each of the second to fourth walls 15b to 15d, but this is not a limitation. It is only necessary that at least one collecting electrode 42 be disposed on each of the collecting electrode-disposed walls.

In the above embodiment, a cross section of the gas flow passage 13 that is perpendicular to the center axis has a substantially rectangular shape, but this is not a limitation. It is only necessary that the gas flow passage 13 have a shape in which the concentration of the particles 17 in the gas is higher in a region close to the center axis. In other words, it is only necessary that the gas flow passage 13 have a shape in which the particles 17 adhere more easily to portions of the collecting electrodes 42 that are close to the center axis of the gas flow passage 13 than to other portions. For example, a cross section of the gas flow passage 13 that is perpendicular to the center axis of the gas flow passage 13 may have an elliptical shape or a polygonal shape other than the rectangular shape.

In the above embodiment, the stacking direction of the first to eleventh layers 14a to 14k and the thickness direction of the first to fourth walls 15a to 15d and the collecting electrodes 42 are both the vertical direction, but this is not a limitation. For example, the stacking direction and the thickness direction may be perpendicular to each other. The casing 12 may not be a layered body.

In the above embodiment, the heater 60 includes the heater electrode 62 embedded in the fourth wall 15d, but this is not a limitation. The heater 60 may be exposed to the gas flow passage 13. The heater 60 may further include a heater electrode embedded in the first wall 15a, i.e., may include a plurality of heater electrodes.

In the above embodiment, the collector 40 includes the plurality of collecting electrodes 42 and the plurality of electric field generating electrodes 44, but this is not a limitation. It is only necessary that the collector 40 include at least one collecting electrode 42 and at least one electric field generating electrode 44. The branched flow passages 13b to 13d may be provided so as to correspond to the number of the collecting electrodes 42. For example, in FIGS. 2 and 3, the casing 12 may not have the second wall 15b and the third wall 15c serving as partitions, and the collector 40 may have one collecting electrode 42 (the third collecting electrode 44c in this case) and one electric field generating electrode 44 (the first electric field generating electrode 44a in this case). Each of the collecting electrodes 42 faces a corresponding one of the electric field generating electrodes 44, but this is not a limitation. For example, the number of electric field generating electrodes 44 may be smaller than the number of collecting electrodes 42. For example, in FIG. 2, the second and third electric field generating electrodes 44b and 44c may be omitted, and the charged particles P may be moved toward the first to third collecting electrodes 42a to 44c through the electric field generated by the first electric field generating electrode 44a. Each of the first to third electric field generating electrodes 44a to 44c causes the charged particles P to move downward, but this is not a limitation. For example, the first collecting electrode 42a and the first electric field generating electrode 44a in FIG. 2 may be arranged in reverse.

In the above embodiment, the first to third collecting electrodes 42a to 44c are connected to one ammeter 52, but this is not a limitation. The first to third collecting electrodes 42a to 44c may be connected to respective ammeters 52. In this manner, the arithmetic unit 54 can compute the numbers of particles 17 adhering to the first to third collecting electrodes 42a to 44c separately. In this case, for example, by applying different voltages to the first to third electric field generating electrodes 44a to 44c or using branched flow passages 13b to 13d having different passage thickness (the vertical heights in FIGS. 2 and 3), the first to third collecting electrodes 42a to 44c can collect particles 17 having respective different particle diameters.

In the above embodiment, the voltage V1 is applied to the first to third electric field generating electrodes 44a to 44c, but no voltage may be applied thereto. Even when the electric field generating electrodes 44 generate no electric field, if the passage thickness of the branched flow passages 13b to 13d is set to a very small value (e.g., 0.01 mm or more and less than 0.2 mm), charged particles P having a relatively small diameter under strong Brownian motion can be caused to collide with the collecting electrodes 42. The collecting electrodes 42 can thereby collect the charged particles P. In this case, the particle detection element 11 may not include the electric field generating electrodes 44.

In the above embodiment, one of the first and second electric charge generators 20a and 20b may be omitted. The ground electrodes 24a and 24b are embedded in the casing 12. However, when a dielectric layer is present between a discharge electrode and an ground electrode, the ground electrode may be exposed to the gas flow passage 13. In the above embodiment, the electric charge generator 20 used includes the discharge electrodes 21a and 21b and the ground electrodes 24a and 24b, but this is not a limitation. For example, an electric charge generator including a needle-shaped electrode and a counter electrode disposed so as to face the needle-shaped electrode with the gas flow passage 13 interposed therebetween may be employed. In this case, when a high voltage (for example, a DC voltage or a high-frequency pulse voltage) is applied between the needle-shaped electrode and the counter electrode, an aerial discharge (corona discharge in this case) occurs due to the potential difference between the two electrodes. When the gas passes through the aerial discharge, charges 18 are imparted to the particles 17 in the gas to form charged particles P, as in the above embodiment. For example, the needle-shaped electrode may be disposed on one of the first and fourth walls 15a and 15d, and the counter electrode may be disposed on the other one.

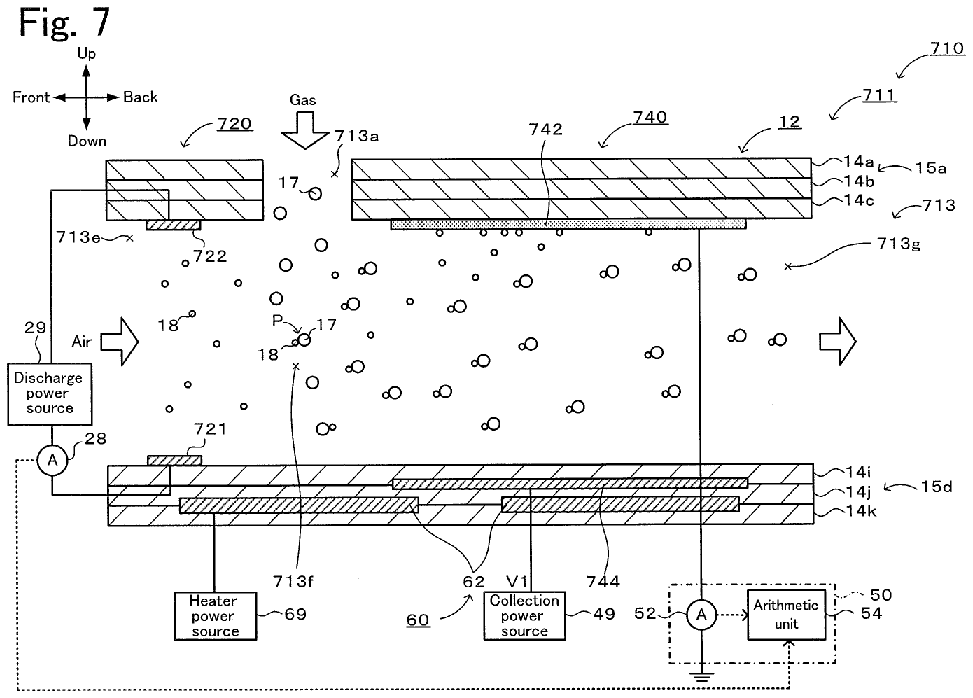

In the above embodiment, the collecting electrodes 42 are disposed on the downstream side of the electric charge generator 20 with respect to the gas flow within the casing 12, and the gas containing the particles 17 is introduced into the casing 12 from the upstream side of the charge generating element 20. However, this structure is not a limitation. In the above embodiment, the collection target of the collecting electrodes 42 is the charged particles P, but the collection target may be charges 18 not imparted to the particles 17. For example, a particle detection element 711 in a modification shown in FIG. 7 and a structure of a particle detector 710 including the particle detection element 711 may be employed. The particle detection element 711 does not include the excess electric charge removing unit 30 and includes an electric charge generator 720, a collector 740, and a gas flow passage 713 instead of the electric charge generator 20, the collector 40, and the gas flow passage 13. The casing 12 of the particle detection element 711 does not include the partitions. The electric charge generator 720 includes a discharge electrode 721 and a counter electrode 722 disposed so as to face the discharge electrode 721. A high voltage is applied between the discharge electrode 721 and the counter electrode 722 from the discharge power source 29. The particle detector 710 includes an ammeter 28 that measures a current when the discharge power source 29 applies the voltage. The collector 740 includes: a collecting electrode 742 disposed on the inner circumferential surface of the gas flow passage 713 of the casing 12 on the same side as the side on which the counter electrode 722 is disposed (the upper side in this case); and an electric field generating electrode 744 embedded in the casing 12 and disposed below the collecting electrode 742. The collecting electrode 742 is connected to the detector 50, and the electric field generating electrode 744 is connected to the collection power source 49. The potential of the counter electrode 722 may be the same as the potential of the collecting electrode 742. The gas flow passage 713 includes an air inlet 713e, a gas inlet 713a, a mixing region 713f, and a gas outlet 713g. The air inlet 713e introduces a gas (air in this case) containing no particles 17 into the casing 12 such that the gas passes through the electric charge generator 20. The gas inlet 713a introduces a gas containing the particles 17 into the casing 12 such that the gas does not pass through the electric charge generator 20. The mixing region 713f is disposed downstream of the electric charge generator 720 but upstream of the collector 740, and the air from the air inlet 713e and the gas from the gas inlet 713a are mixed in the mixing region 713f. The gas outlet 713g discharges the gas passing through the mixing region 713f and the collector 740 to the outside of the casing 12. In this particle detector 710, the size of the collecting electrode 742 and the intensity of the electric field on the collecting electrode 742 (i.e., the magnitude of the voltage V1) are set such that the charged particles P are discharged from the gas outlet 713g without being collected by the collecting electrode 742 and that charges 18 not imparted to the particles 17 are collected by the collecting electrode 742.

In the thus-configured particle detector 710 in FIG. 7, when the discharge power source 29 applies a voltage between the discharge electrode 721 and the counter electrode 722 such that the discharge electrode 721 side has a higher potential, an aerial discharge occurs in the vicinity of the discharge electrode 721. In this case, charges 18 are generated in air between the discharge electrode 721 and the counter electrode 722 and imparted to the particles 17 in the gas within the mixing region 713f. Therefore, although the gas containing the particles 17 does not pass through the electric charge generator 720, the electric charge generator 720 can convert the particles 17 to the charged particles P, as does the electric charge generator 20.

In the particle detector 710 in FIG. 7, the voltage V1 applied by the collection power source 49 causes an electric field directed from the electric field generating electrode 744 toward the collecting electrode 742 to be generated, and the collecting electrode 742 thereby collects the collection target (the charges 18 not imparted to the particles 17 in this case). The charged particles P are not collected by the collecting electrode 742 and are discharged from the gas outlet 713g. The arithmetic unit 54 obtains, as an input, the current value based on the charges 18 collected by the collecting electrode 742 from the ammeter 52 and detects the number of particles 17 in the gas based on the input current value. For example, the arithmetic unit 54 determines the number of charges 18 (the number of transmitted charges) transmitted through the gas flow passage 13 without being collected by the collecting electrode 742 by deriving the current difference between a current value measured by the ammeter 28 and a current value measured by the ammeter 52 and dividing the derived current difference value by the elementary charge. Then the arithmetic unit 54 computes the number Nt of particles 17 in the gas by dividing the number of transmitted charges by the average number of charges 18 (the average charge number) imparted to one particle 17. Even when the collection target of the collecting electrode 742 is not the charged particles P but the charges 18 not imparted to the particles 17 as described above, the number of particles 17 in the gas can be detected using the particle detection element 711 because there is a correlation between the number of collection target objects collected by the collecting electrode 742 and the number of particles 17 in the gas.

In the particle detector 710 in FIG. 7, the collection target of the collecting electrode 742 is not the charged particles P but the charges 18 not imparted to the particles 17. Even in this case, the particles 17 may gradually adhere to the collecting electrode 742 during the use of the particle detection element 711. In the particle detector 710, as in the above-described embodiment, the first wall 15a of the casing 12, which is a collecting electrode-disposed wall on which the collecting electrode 742 is disposed, has the thin-central wall shape. Therefore, in the particle detection element 711, as in the abode-described embodiment, the particles 17 adhering to the collecting electrode 742 can be removed in a shorter time. When the collection target of the collecting electrode 742 is the charges 18 not imparted to the particles 17, the arithmetic unit 54 can detect the number of particles 17 in the gas even during burning of the particles 17 by the heater 60. However, when a large number of particles 17 adhere to the collecting electrode 742, the accuracy of detection of the number of particles 17 may deteriorate because of the influence of the particles 17 on the flow of the gas in the gas flow passage 13. The detection accuracy may deteriorate due to an increase in temperature in the casing 12 caused by the heater 60. Therefore, in the particle detection element 711 also, it is preferable to remove the particles 17 adhering to the collecting electrode 742 in a shorter time.

In the particle detection element 711 in FIG. 7, the collection ratio of charges 18 may be determined in advance in consideration of the ratio of the charges 18 not collected by the collecting electrode 742 among the charges 18 not imparted to the particles 17. In this case, the arithmetic unit 54 may derive the current difference by subtracting a value obtained by dividing the current value measured by the ammeter 52 by the collection ratio from the current value measured by the ammeter 28. The particle detector 710 may not include the ammeter 28. In this case, for example, the arithmetic unit 54 adjusts the voltage applied from the discharge power source 29 such that a prescribed number of charges 18 are generated per unit time. The arithmetic unit 54 derives the current difference between a prescribed current value (the current value corresponding to the prescribed number of charges 18 generated by the electric charge generator 720) and the current value measured by the ammeter 52.

In the above embodiment, the detector 50 detects the number of particles 17 in the gas, but this is not a limitation. The detector 50 may detect the particles 17 in the gas. For example, the detector 50 may not detect the number of particles 17 in the gas but may detect the amount of the particles 17 in the gas. Examples of the amount of the particles 17 include, in addition to the number of particles 17, the mass of the particles 17, and the surface area of the particles 17. When the detector 50 detects the mass of the particles 17 in the gas, the arithmetic unit 54 may determine the mass of the particles 17 in the gas, for example, by multiplying the number Nt of particles 17 by the mass (e.g., the average mass) of one particle 17. Alternatively, the relation between the amount of accumulated charges and the total mass of collected charged particles P may be stored as a map in the arithmetic unit 54 in advance, and the arithmetic unit 54 may directly derive the mass of the particles 17 in the gas from the amount of accumulated charges using the map. When the arithmetic unit 54 determines the surface area of the particles 17 in the gas, a method similar to the method for determining the mass of the particles 17 in the gas may be used. When the collection target of the collecting electrodes 42 is charges 18 not imparted to the particles 17, the detector 50 can detect the mass or surface area of the particles 17 using a similar method.

In the description of the above embodiment, the number of positively charged particles P is measured. However, the number of particles 17 can be measured in a similar manner when the charged particles P are negatively charged.

The present application claims priority from Japanese Patent Application No. 2017-171120 filed Sep. 6, 2017, the entire contents of which are incorporated herein by reference.

What is claimed is:

1. A particle detection element used to detect particles in a gas, the particle detection element comprising:
a casing having a gas flow passage through which the gas passes;
an electric charge generating unit that imparts charges generated by a discharge to the particles in the gas introduced into the casing to thereby form charged particles;
a collecting unit including at least one collecting electrode that is disposed inside the casing so as to be exposed to the gas flow passage and collects a collection target that is the charged particles or the charges not imparted to the particles; and
a heating unit that heats the collecting electrode,
wherein the casing includes at least one collecting electrode-disposed wall on which at least one of the at least one collecting electrode is disposed, and
wherein at least one of the at least one collecting electrode-disposed wall has a thin-central wall shape whose thickness in a cross section perpendicular to a center axis of the gas flow passage is smaller in a central portion than in other portions.

2. The particle detection element according to claim 1,
wherein the casing includes a partition that partitions the gas flow passage, and
wherein at least one of the at least one collecting electrode-disposed wall having the thin-central wall shape serves as the partition.

3. The particle detection element according to claim 2,
wherein the casing comprises a plurality of the collecting electrode-disposed walls having the thin-central wall shape, and
wherein at least one of the collecting electrode-disposed walls having the thin-central wall shape serves as an outer wall of the casing.

4. The particle detection element according to claim 1,
wherein at least one of the at least one collecting electrode-disposed wall having the thin-central wall shape has a shape whose thickness in the cross section gradually decreases toward the central portion.

5. The particle detection element according to claim 1,
wherein at least one of the at least one collecting electrode has the thin-central wall shape.

6. The particle detection element according to claim 1,
wherein the collecting unit includes at least one electric field generating electrode that is exposed to the gas flow passage and generates an electric field that causes the collection target to move toward at least one of the at least one collecting electrode,
the casing includes at least one electric field generating electrode-disposed wall on which at least one of the at least one electric field generating electrode is disposed, and
at least one of the at least one electric field generating electrode-disposed wall has the thin-central wall shape.

7. The particle detection element according to claim 1,
wherein a cross section of the gas flow passage that is perpendicular to the center axis of the gas flow passage has a rectangular shape.

8. The particle detection element according to claim 1,
the particle detection element comprises a plurality of exposed electrodes that are exposed to the gas flow passage and comprise the at least one collecting electrode,
the casing has a connection wall portion having the thin-central wall shape and having a connection surface that is part of an inner circumferential surface exposed to the gas flow passage and connects at least two of the plurality of exposed electrodes to each other, and
wherein the heating unit heats the connection wall portion.

9. A particle detector comprising:
the particle detection element according to claim 1; and
a detection unit that detects the particles based on a physical quantity that varies according to the collection target collected by the collecting electrode.
